(19) United States
(12) Patent Application Publication
(10) Pub. No.: US 2002/0027183 A1
(43) Pub. Date: Mar. 7, 2002

(54) Assembling structure for ceiling fan bracket

(76) Inventor: Tien Fu Tseng, Taichung Hsien (TW)

Correspondence Address: ROSENBERG, KLEIN & LEE, 3444 ELLICOTT CENTER DRIVE-SUITE 105, ELLICOTT CITY, MD, 21043, US

(21) Appl. No.: 09/745,871

(22) Filed: Dec. 26, 2000

Related U.S. Application Data
(63) Continuation-in-part of application No. 09/653,694, filed on Sep. 1, 2000.

(51) Int. Cl. A47K 1/00; E04G 3/00; F21V 21/00

(52) U.S. Cl. 248/220.21

(57) ABSTRACT

An assembling structure for ceiling fan bracket, including a hollow assembling section. The circumference of the assembling section is formed with multiple sockets in each of which a bracket is inserted. The socket has a shape complementary to the shape of the cross-section of the bracket. A movable locating member is disposed between the bracket and the socket for fixedly locating the bracket in the socket. An inner end face of the socket is formed with a projecting section as an isosceles triangular column. The bracket is formed with a recessed section corresponding to the projecting section, whereby the bracket is fixedly and accurately located in the socket by a restricted angle without easy loosening.

### CROSS-REFERENCE TO RELATED APPLICATION

This application is a Continuation-In-Part Application of Ser. No. 09/653,694 filed Sep. 1, 2000, and entitled “ASSEMBLING STRUCTURE FOR CEILING FAN BRACKET”

### BACKGROUND OF THE INVENTION

The present invention relates to an assembling structure for ceiling fan bracket, which enables a user to easily assemble and disassemble the bracket without loosening.

FIG. 8 shows a conventional ceiling fan 8. The vane 91 of the ceiling fan 9 are locked on a bracket 92 which is locked on a motor housing 94 by bolts 93.

When storing or transferring the ceiling fan 9, the brackets 92 are detached and the main body of the ceiling fan 9 and the brackets 92 are separately packed to reduce the volume. When a user himself assembles the ceiling fan, the user must use the bolts 93 to lock the brackets 92 on the motor housing 94. In general, the ceiling fan 9 has at least four brackets 92 each necessitating at least two bolts 93 for locking the bracket 92. That is, it is necessary to screw at least eight bolts 93 for assembling a ceiling fan 9. Therefore, the DIY assembly is time-consuming. Moreover, when screwing the bolts 93, it is hard for the user to properly control the pressure and tightness for locking the bolts 93. In case some of the bolts 93 are not completely tightened, the centrifugal force of the rotational vane 91 may make the bolts 93 loosen or even make the vane 91 and the bracket 92 detach from the housing and fly out to hurt people. Especially, some users like to select different colors and styles of brackets 92 and vanes 91 and variably DIY assemble the brackets 92 and vanes 91 with the housing in accordance with situations and moods. As a result, the user often incautiously fails to firmly lock the brackets 92 and vanes 91 which may fly out to put people in danger.

In addition, the brackets 92 are locked on the motor housing 94 by bolts 93. However, the motor housing 94 has a limited thickness, that is, the thread holes formed on the motor housing 94 have short length. During repeatedly screwing the bolts 93 for assembling and disassembling the brackets 92, the thread may be broken. This will make it impossible to fixedly lock the bracket 92. Therefore, it is necessary to eliminate the above problems existing the screwing measure of the bolts 93 for locking the bracket 92.

### SUMMARY OF THE INVENTION

It is therefore a primary object of the present invention to provide an assembling structure for ceiling fan bracket in which a locating member is disposed between the bracket and the socket for locating the bracket therein so that the bracket can be easily assembled and disassembled for replacement. The inner face of the socket is formed with slide rails and the bracket is formed with corresponding slide channels. Each slide rail has a thickness gradually increased from outer side to inner side. Therefore, after inserted into the socket, the bracket is firmly associated with the motor housing without loosening.

It is a further object of the present invention to provide the above assembling structure for ceiling fan bracket in which the inner end face of the socket is formed with a projecting section as an isosceles triangular column. The end face of the bracket is formed with a recessed section having a shape complementary to the projecting section. The projecting section is cooperatively inserted into the recessed section and guided and restricted thereby to form a guiding/locating structure. By means of the guiding/locating structure, after the bracket is inserted into the socket, the bracket is firmly fixed by a restricted correct angle without loosening. Therefore, the shortcoming of horizontal swinging of the bracket caused by inaccurate fitting of the slide rail with the slide channel can be eliminated. In addition, the bracket is located in a correct direction so that the distributed weights of the brackets of the ceiling fan are equal to each other. Therefore, the torque central axis will fall onto the axis of the rotary shaft of the motor and the ceiling fan can rotate in a more stable and balanced state so as to ensure safety.

The present invention can be best understood through the following description and accompanying drawings wherein:

### BRIEF DESCRIPTION OF THE DRAWINGS

FIG. 1 is a perspective assembled view of the present invention;

FIG. 2 is a perspective exploded view of a part of the present invention;

FIG. 3 is a sectional assembled view of the bracket and the assembling section of the present invention, taken along line III-III of FIG. 1;

FIG. 4 is a sectional view taken along line IV-IV of FIG. 2;

FIG. 5 is a sectional view taken along line V-V of FIG. 2; and

FIG. 6 is a perspective exploded view of a second embodiment of the present invention;

FIG. 7 is a sectional assembled view of the bracket and the assembling section of the second embodiment of the present invention; and

FIG. 8 is a perspective exploded view of a conventional ceiling fan.

### DETAILED DESCRIPTION OF THE PREFERRED EMBODIMENT

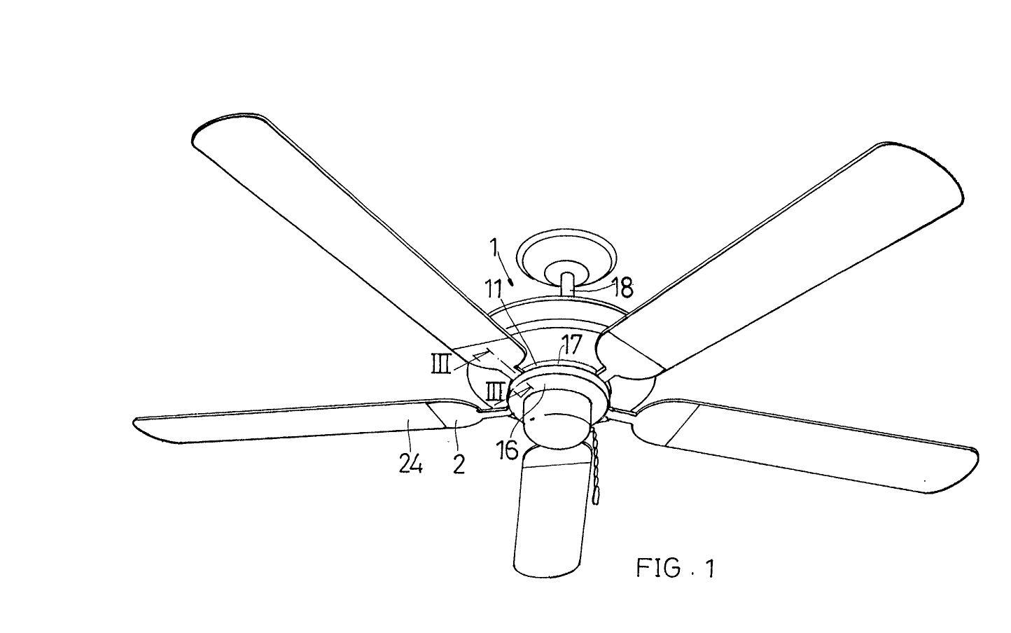

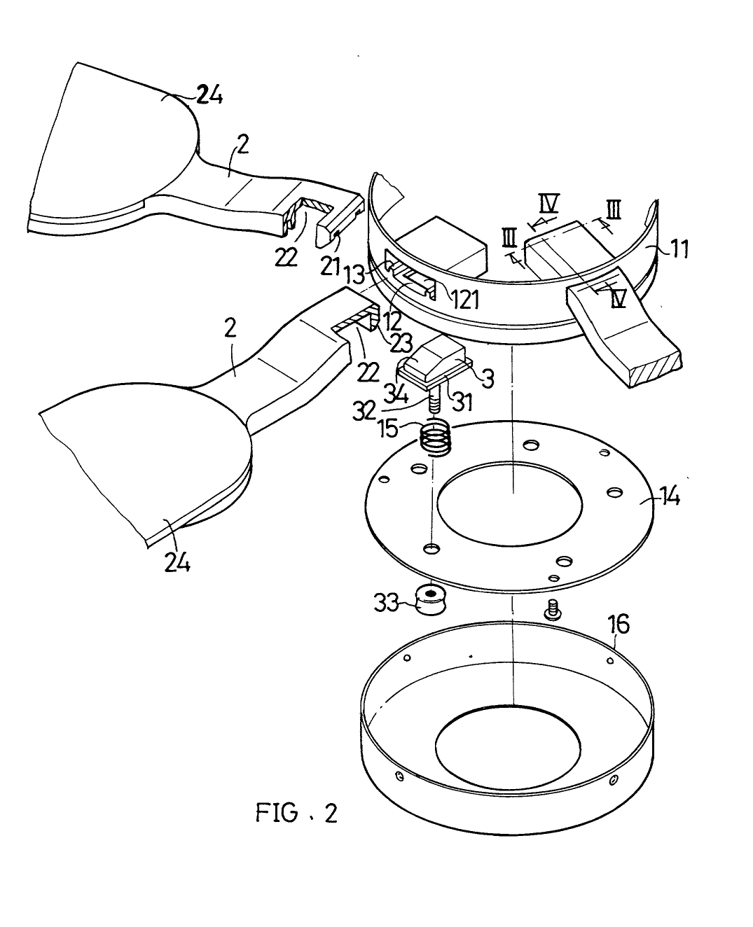

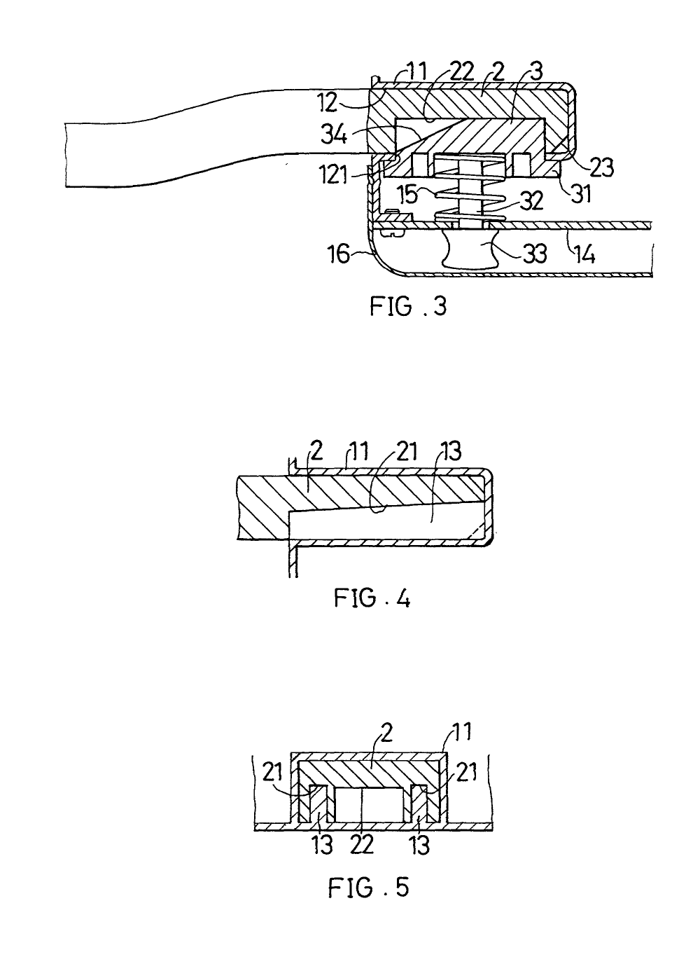

FIGS. 1 to 5 show the assembling structure for the bracket of a ceiling fan 1 according to the present invention. The assembling structure includes a motor (not shown), a hollow assembling section 11, multiple brackets 2 and a base board 14. The motor has a housing 17 and a rotary shaft 18. The assembling section 11 is connected with a lower portion of the housing 17 of the motor. The base board 14 is connected with a lower portion of the assembling section 11. The circumference of the assembling section 11 is formed with multiple sockets 12 inward radially extending from outer edge. A bracket 2 connected with a vane 24 is inserted in each socket 12. The socket 12 has a shape complementary to the shape of the cross-section of the bracket 2. Two sides of the bottom face of the socket 12 are respectively formed with two slide rails 13. The thickness of each slide rail 13 is gradually increased from outer side to inner side. The bracket 2 is formed with two slide channels 21 corresponding to the two slide rails 13 for cooperatively fitting with the slide rails 13. The bottom face of the socket 12 is formed with a perforation 121. A locating member 3 is upward extended through the perforation 121. The bottom face of the locating member 3 is formed with a stop flange 31 for abutting against outer edge of the bottom face of the socket 12. A spring 15 is disposed between the locating member 3 and a base board 14 of the assembling section 11. The spring 15 in normal state pushes the locating member 3 upward. The locating member 3 has a post 32 downward extending out of the base board 14 of the assembling section 11. A knob 33 is connected with a bottom end of the post 32 for leaning against the bottom face of the base board 14. The bracket 2 is formed with an engaging section 22 corresponding to the locating member 3. The locating member 3 is engaged with the engaging section 22 for locating the bracket 2. The locating member 3 has a guide slope 34 formed on one side thereof facing the circumference of the assembling section 11. The front edge of the bracket 2 is formed with a guide angle 23 corresponding to the guide slope 34. In addition, the bottom of the assembling section 11 is covered by a cover member 16 for shielding the knobs 33 of the locating members 3.

The locating member 3 is disposed on the inner face of the socket 12 of the assembling section 11 of the motor housing and the bracket 2 is formed with an engaging section 22 corresponding to the locating member 3. Therefore, when assembled, a user only needs to insert the bracket 2 into the socket 12 to engage the engaging section 22 with the locating member 3 for fixing the bracket 2 without using any bolt. Therefore, the user can much more conveniently assemble the ceiling fan. Moreover, the inner side of the socket 12 is formed with slide rails 13 and the bracket 2 is formed with corresponding slide channels 21. The thickness of each slide rail 13 is gradually increased from outer side to inner side. Therefore, after the bracket 2 is inserted into the socket 12, the bracket 2 is firmly associated with the motor housing without loosening. Furthermore, the locating member 3 has a post 32 extending out of the base board 14 of the assembling section 11 and a knob 33 is connected with the bottom end of the post 32. Therefore, it is observed whether the knob 33 is positioned adjacent to the base board 14 so as to judge whether the locating member 3 is correctly inlaid in the engaging section 22 of the bracket 2. Therefore, it can be ensured that the bracket 2 is firmly assembled without loosening. When disassembling the bracket 2, the user only needs to downward pull the knob 33 of the locating member 3 to make the locating member 3 disengaged from the engaging section 22 of the bracket 2. Then the bracket 2 is outward pulled and taken out for cleaning or replacement. Such procedure is quite convenient for the user to perform.

According to the above arrangement, the present invention has the following advantages:

1. The bracket 2 is assembled only by means of inserting the bracket 2 into the socket 12 to be engaged with and located by the locating member 3. Therefore, the assembling and disassembling procedures are facilitated.

2. The slide rails 13 and the locating member 3 cooperate with each other to make the bracket 2 more firmly associated with the motor housing without loosening.

3. By means of observing whether the knob 33 of the locating member 3 is positioned adjacent to the base board 14, it can be judged whether the locating member 3 is correctly inlaid in the engaging section 22 of the bracket 2. Therefore, it can be ensured that the bracket 2 is firmly assembled without loosening.

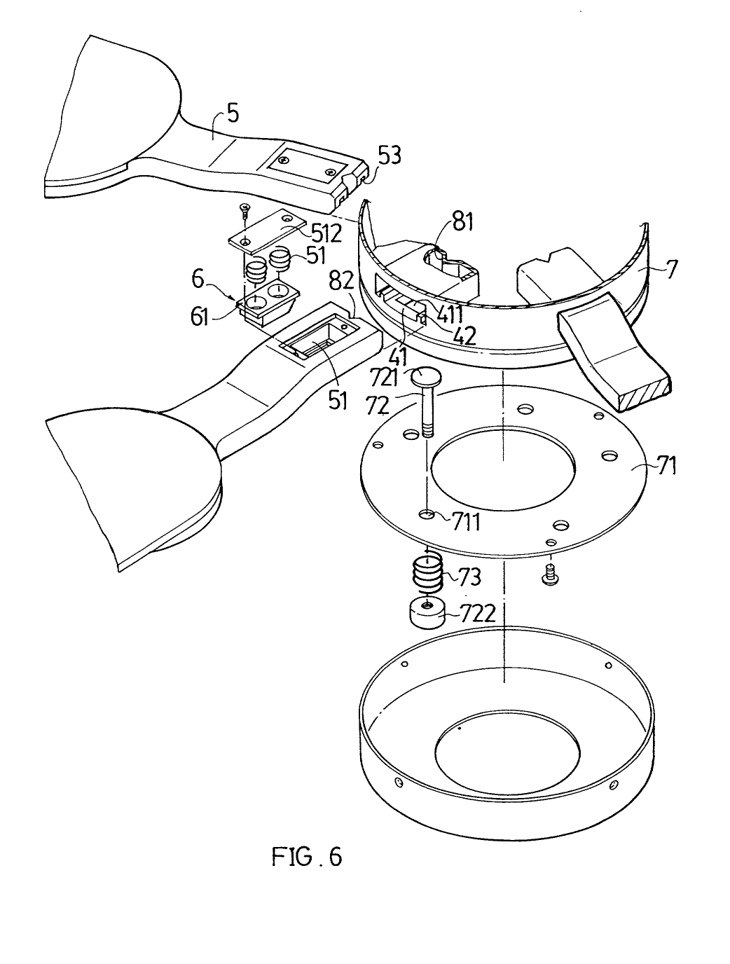

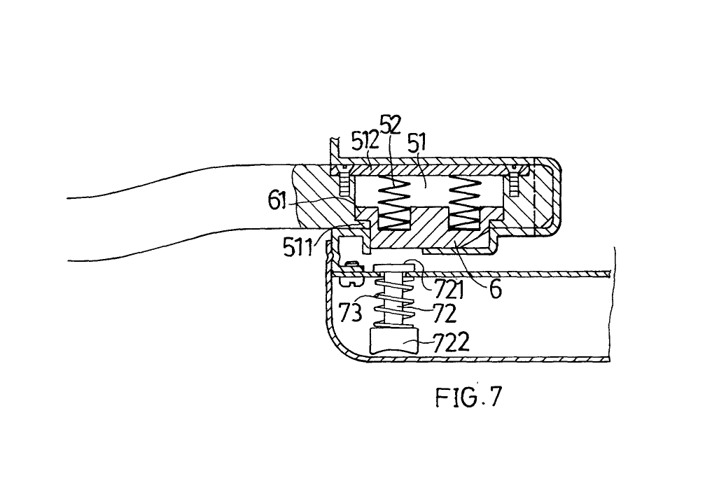

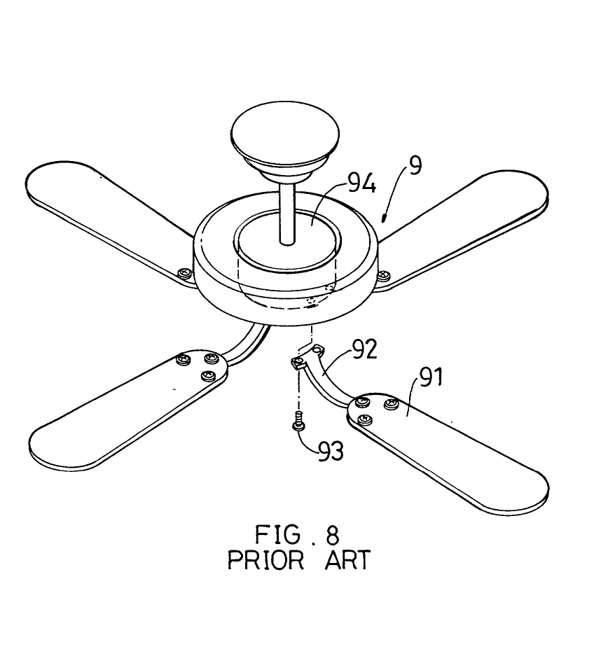

FIGS. 6 and 7 show a second embodiment of the present invention, in which the top face of one end of the bracket 5 inserted in the socket 41 is formed with a cavity 51. A cover plate 512 is locked with the bracket 5 for covering the cavity 51. A locating member 6 is disposed in the cavity 51. The socket 41 is formed with an engaging section 411 corresponding to the locating member 6. The cavity 51 has an opening facing downward. The opening is formed with a flange 511. The circumference of the top face of the locating member 6 is formed with a stop flange 61 corresponding to the flange 511 and stopped thereby. At least one resilient member 52 is disposed between the locating member 6 and the cover plate 512 of the cavity 51. The resilient member 52 serves to push the locating downward to engage with the engaging section 411.

The base board 71 on lower edge of the assembling section 7 is formed with several through holes 711. The engaging section 411 is formed with a hole 412 corresponding to the through hole 711. A movable pin 72 is passed through the through hole 711. One end of the pin 72 is formed with a flange 721, while the other end thereof is screwed with a button 722. A spring 73 is fitted on the pin 72 between the base board 71 and the button 722. The spring 73 serves to push the pin 72 downward to make the flange 721 stopped by the base board 71. The flange 721 can be upward extended through the hole 412 of the engaging section 411.

Referring to FIG. 6, the inner end face of the socket 41 is formed with a projecting section 81 as an isosceles triangular column. The end face of the bracket 5 is formed with a recessed section 82 having a shape complementary to the projecting section 81. The projecting section 81 is cooperatively inserted into the recessed section 82 and guided and restricted thereby to form a guiding/locating structure.

By means of the guiding/locating structure 81, 82 and the slide rail 42, after the bracket 5 is inserted into the socket 41, the bracket 5 is firmly fixed by a restricted correct angle without loosening. Therefore, the shortcoming of horizontal swinging of the bracket 5 caused by inaccurate fitting of the slide rail 42 with the slide channel 53 can be eliminated. In addition, the bracket 5 is located in a correct direction so that the distributed weights of the brackets 5 of the ceiling fan are equal to each other. Therefore, the torque central axis will fall onto the axis of the rotary shaft of the motor and the ceiling fan can rotate in a more stable and balanced state so as to ensure safety.

The above embodiment is only used to illustrate the present invention, not intended to limit the scope thereof. Many modifications of the above embodiment can be made without departing from the spirit of the present invention.

What is claimed is:

1. An assembling structure for ceiling fan bracket, comprising a motor, a hollow assembling section, multiple brackets and a base board, the motor having a housing and a rotary shaft, the assembling section being connected with a lower portion of the housing of the motor, the base board being connected with a lower portion of the assembling section, a circumference of the assembling section being formed with multiple sockets inward radially extending from outer edge of the assembling section, a bracket connected with a vane being inserted in each socket, the socket having a shape complementary to the shape of the cross-section of the bracket, a locating member being movably disposed on inner face of the socket, the bracket being formed with an engaging section corresponding to the locating member for engaging with the locating member to fixedly locate the bracket.

2. An assembling structure for ceiling fan bracket as claimed in claim 1, wherein each socket of the assembling section is formed with two parallel slide rails, each slide rail having a thickness gradually increased from outer side to inner side, the bracket being formed with two slide channels corresponding to the two slide rails for cooperatively fitting with the slide rails.

3. An assembling structure for ceiling fan bracket as claimed in claim 1, wherein each socket is formed with a perforation in which the locating member is upward fitted, the locating member being formed with a stop flange stopped by the edge of the socket, a spring being disposed between the locating member and a base board of the assembling section, the spring in normal state pushing the locating member upward, the locating member having a post downward extending out of the base board of the assembling section, a knob being connected with a bottom end of the post for leaning against the bottom face of the base board.

4. An assembling structure for ceiling fan bracket as claimed in claim 1, wherein the locating member has a guide slope, a front edge of the bracket being formed with a guide angle corresponding to the guide slope, whereby when the bracket is inserted into the socket, the guide slope serves to cooperatively guide the guide angle.

5. An assembling structure for ceiling fan bracket as claimed in claim 1, wherein the bottom of the assembling section is covered by a cover member.

6. An assembling structure for ceiling fan bracket comprising:
a motor having a housing and a rotary shaft;
a hollow assembling section connected with a lower portion of the housing of the motor, a circumference of the assembling section being formed with multiple sockets inward radially extending from outer edge of the assembling section, the socket having an inner close end face; and
multiple brackets each of which is connected with a vane, the bracket having a cross-sectional shape complementary to the shape of the cross-section of the socket, a locating member being between the bracket and the socket for fixedly locating the bracket in the socket, said assembling structure being characterized in that:
each bracket has a downward movable locating member and each socket is formed with an engaging section corresponding to the locating member, at least one resilient member being disposed between the locating member and the bracket for pushing the locating member downward to engage with the engaging section; and
an inner end face of the socket is formed with a projecting section as an isosceles triangular column, an end face of the bracket being formed with a recessed section corresponding to the projecting section and having a shape complementary to the projecting section.

7. An assembling structure for ceiling fan bracket as claimed in claim 6, wherein the assembling section is fixedly connected with a base board formed with several through holes, the engaging section being formed with a hole corresponding to each through hole, a movable pin being passed through the through hole, one end of the pin being formed with a flange, while the other end thereof being connected with a button, a spring being fitted on the pin between the base board and the button, the spring serving to push the pin downward to make the flange thereof stopped by the base board, the flange being upward extendable through the hole of the engaging section.
